(19) United States
(12) Patent Application Publication
(10) Pub. No.: US 2018/0347550 A1
(43) Pub. Date: Dec. 6, 2018

(54) DEVICE PROVIDING NON-INERTIAL PROPULSION WHILE CONSERVING PROPELLANT MASS AND METHOD THEREFOR

(71) Applicant: Henry Lewis LaMuth, Columbus, OH (US)

(72) Inventor: Henry Lewis LaMuth, Columbus, OH (US)

(21) Appl. No.: 15/996,934

(22) Filed: Jun. 4, 2018

Related U.S. Application Data
(60) Provisional application No. 62/603,539, filed on Jun. 5, 2017.

(51) Int. Cl. F03G 3/00; F03B 17/00; F03B 13/00; F03B 15/02

(52) U.S. Cl. CPC F03G 3/00; F03B 17/00; B64G 1/409; F03B 15/02; F03B 13/00

(57) ABSTRACT

Propulsion is achieved without expelling matter by a non-inertial subsystem to generate substantial internal Coriolis recoil forces that supply propulsion. A subsystem discretely injects mass (fluids) radially into a non-inertial system having spinning radially-oriented fins mounted on a thin disc. The mass (fluid) is input at the circumference of the spinning system by radially injecting the fluid at high velocity onto one fin at a time at the outer end thereof. The mass centrifugally slows as it travels toward the axis and leaves the system at a very low velocity near the axis of rotation. The resultant integrated non-linear Coriolis reaction or recoil is constrained to acting through the axis of rotation of the spinning vanes by keeping the rotation rate constant. The net integrated reactive force acting on the axis of rotation of the subsystem produces a propulsive force. The injected and retarded fluids are captured near the rotation axis and recirculated to the input injectors. By conserving the reaction mass, the closed propulsion system depends only on the availability of power from a source.

### CROSS-REFERENCE TO RELATED APPLICATIONS

This application is a non-provisional of, and claims priority to, U.S. provisional application 62/603,539, filed on 5 Jun. 2017, which is incorporated by reference as if fully recited herein.

### TECHNICAL FIELD

The disclosed embodiments of the present invention relate to devices that provide propulsion force without expelling matter, by means of the operation and assembly of novel rotational non-inertial subsystems as well as the integration of commercial technologies using engineering arts well known to the automotive and aerospace industries. The present invention device operates in the nature of a motion converter, using the Coriolis effect to convert rotational motion into a linear recoil movement.

### BACKGROUND ART

To the best of the inventor's knowledge, there is no prior art describing the key subsystem that allow the described invention to achieve propulsion.

In a certain number of technological applications, it would be clearly advantageous to provide propulsion while conserving propellant mass. One such technological application exists in outer space and in the effort to propel a space vehicle literally into, and through, a volume of space where there is no opportunity to replenish the propellant mass. Some of these opportunities also exist in terrestrial applications.

### SUMMARY

These and other unmet needs of the prior art are met by a device whose key subsystem is a rotating finned disc plus fluid injectors in a specific geometry that enables propulsion. With this key subsystem, linear movement or propulsion is achieved while conserving propulsion mass. The key subsystem employs the asymmetrical injection of fluids onto a spinning disc upon which an array of radial fins is mounted.

Currently, the use of fins appears to be preferred, but other embodiments, such as a plurality of tubes of a particular cross section, may be able to achieve the effect of linear propulsion without ejection of propulsion mass.

The design and operation of the finned discs, using discrete fluid pulses injected at each fin with the disc array spinning at a constant rate, produces reactive Coriolis propulsive forces on the center of mass of the spinning discs or array of discs. The Coriolis force are manifest on the drive shaft for the arrays, and this reactive Coriolis force on the rotation shaft produces a net propulsive force on the system. The spin rate must remain constant regardless of the load on the disc array for the Coriolis recoil force to act through the center of mass of the array with a well-defined resultant magnitude and direction.

By collecting and recycling the injected mass after it has dynamically interacted with the fins on the spinning discs and produced reactive Coriolis forces allows for a closed system in which propulsive mass is not lost or ejected from the system in producing propulsion.

The arrays of finned discs, in either an expeller or retarder configuration, which notation is defined and clarified later and with the retarder configuration the preferred configuration, can, along with the injectors plus recycling and local control system, exist as a standalone retarder or expeller module, which can be further clustered into a larger standalone module that also contains the driver motor or turbine and a power source. Such modularization allows multiple standalone propulsion modules to be clustered and to be interfaced with a master controller that supplies systems level commands that coordinate the functioning and overall vehicle control. Such integration facilitates assembly, disassembly, fabrication, and repairs to each internal subsystem of the module by a priori designing such modules and subsystems to be consistent with the logistics in widespread use for propulsion systems used for both military and commercial purposes.

Self-contained propulsion modules can be clustered to supply additional thrust for larger vehicles, limited primarily by the power-to-mass ratios of the power sources.

The magnitude of the acceleration from the Coriolis recoil forces depends on the total mass of the entire system, which includes the mass of the integrated propulsion modules, vehicle, cargo, and consumable masses for any given mission.

In low powered space systems, electric motors driven by solar or thermal nuclear power sources can drive the retarder module in producing low continuous thrust for repositioning space objects.

New classes of high-power compact nuclear reactors will have large power-to-mass ratios that can supply sufficient power to retarder propulsion models to move massive objects from the Earth's surface to any location in the solar system and beyond.

The curvature of the retarder fins, or the replacement of fins by tubes of some cross section and curvatures, if any, is uniquely determined by the design requirements, empirical findings, and mechanization of the retarder, including but not limited to fluid dynamics and stresses on the fins or tubes and by the requirements to contain the injected fluids during the retarding process for all retarder orientations and for all retarder environments. Also, an array forms a natural rectangular cross section tube for containing the injected fluids and, consequently, the shapes of the fins would need to also be taken into consideration to ensure an optimal confinement of the injected fluids during the operation of the retarder.

The design of the retarder in terms of size, spin rates, and mass throughput are determined by the application and injector requirements. The discrete fluid mass input to the retarder is at one specific angular location for all vanes for all retarders in each retarder array. The fluid can be some liquid such as but not necessarily limited to water or can be a slurry such as a ferrofluid, which may require special modifications to the injector and recycling system.

The fluid output of the retarder or expeller is a continuous stream of droplets that exit the retarder at a specific angular location relative to the discrete input location and with a fixed velocity (speed and direction) determined by the design for any application for the retarder, including the input location and speed of the injected fluid droplets.

While the expeller array is not necessarily the preferred embodiment for purposes of propulsion, the expeller is a pump or mass driver with unique characteristics, including but not limited to the fact that mass is accelerated without using hydrodynamic pressures, which may be useful in moving fluids that are susceptible to mechanical damage, such as but not limited to blood. The accelerated or decelerated droplets in expellers and retarders are accelerated or decelerated, respectively, with pure centrifugal forces and there is no hydrodynamic fluid flow or pressures within the expeller or retarder except those that might be collaterally caused by confining the droplets to move within the tube-like structures produced by stacking the finned rotating discs onto a common rotation shaft.

The output stream of droplets from each rotating finned disc is collected by an inelastic target which converts the output stream's momentum into a recoil force that is part of the overall recycle system's total net momentum change, which is orders of magnitude less than the net resultant linear Coriolis recoil force.

The output of an expeller can be input into a retarder, which could reduce the overall mechanical impact on pumped materials in moving these materials from one location to another and minimizing the inelastic forces that may damage certain materials being pumped, since the output velocity of the retarded materials is typically less than the output velocity of the expeller.

With regards to the fabrication of the fins on the expeller or retarder configurations, the material from which the fins are fabricated or coated can be application specific to reduce or eliminate friction of the accelerated fluid as it is slides along the fin, which also reduces or eliminates erosion of the fins from the accelerated fluid.

It is believed that friction can be reduced, if required, in an application by allowing air or some gas to be accelerated along the fin, forming a laminar layer on the surface of the fin, thereby reducing friction.

Further, the fins may be heated so as to create a vapor barrier between the accelerating mass and the fin supplying the acceleration, or in the case of ferrofluid, some repulsive field can be used to “levitate” the droplet above the surface of the fin.

The input to the injectors uses conventional pumps and fluid injection technology to supply mass droplets of the requisite mass, droplet size distribution, and volume at well-timed intervals and with the requisite velocities. The net reactive forces from the recirculating pumps moving the fluid from the output of the arrays back to the injectors will be small compared to the net integrated Coriolis recoil forces.

The recoil forces both from the injector input to an array of retarders or expellers and from the recoil from the output of an array of retarders or expellers as the fluids are captured by the recycling system produce forces that are not parallel or antiparallel to the integrated Coriolis forces unless the design arbitrarily happens to cause this to occur. The injector and output recoil forces are also much smaller than the Coriolis recoil forces. As a result, the expeller or retarder configurations represent a subsystem for which the reaction to forces on a mass does not produce an equal and opposite reaction in the system.

The integrated Coriolis forces against a fin average out to a net specific direction and magnitude of the recoil forces, and the integration of all these forces from all the fins produces an integrated Coriolis recoil force on the spin shafts within the arrays, which when summed together determines the direction and magnitude of the produced thrust on the system.

The unique method by which the retarder operates at a constant spin rate creates a recoil force on the retarder fins that has no counter reaction within the system other than directly through the center of mass of the retarder subsystem.

Retarders can be mounted or stacked in an array on a keyed shaft to increase the mass throughput of the system. Multiple array pairs can be used to counter various internal torques and to control the amount of mass that must be injected onto each fin, which is a function of the technology for the injectors and the requirements for the inject mass to be injected at a specific volume and velocity.

The arrangements of the propulsion modules within a closed system can be used to avoid torques on the system resulting from unbalanced forces not acting through the center of mass of the total system, where system in this case refers to some vehicle which may contain multiple propulsion modules.

### BRIEF DESCRIPTION OF THE DRAWINGS

A better understanding of the invention will be obtained when reference is made to the appended drawings, wherein identical parts are identical reference numbers and wherein:

FIG. 1 shows, in top perspective view, a radially-finned disc that is a component of an embodiment of the inventive device;

FIG. 2 shows, in top perspective view, an assembly in which a plurality of the FIG. 1 discs is assembled on a shaft;

FIG. 3 shows, in cross-sectional view, an enlarged view of the coupling of a disc to the shaft of FIG. 2;

FIG. 4 shows, in perspective view, the operation of the assembled device of FIG. 2;

FIG. 5 shows the device of FIG. 4 in operative engagement with a source of rotation;

FIG. 6 schematically depicts the forces in effect with regard to an individual disc of FIG. 1; and

FIG. 7 schematically depicts fluid flow and momentum paths in a typical conventional closed-cycle circulation system in which back-to-back counter-rotating pumps eliminate motor torques.

### DETAILED DESCRIPTION OF THE DRAWINGS

A major difference between existing technologies and the system of the present disclosure is that the present exploitation of non-symmetrical mechanical embodiments. Very few spinning or rotating mechanical systems exhibit asymmetrical loading, though the crank shaft in a piston engine does exhibit some asymmetry in how the force from a piston creates torques that spin the crankshaft. However, the critical subsystem in the current invention is effectively a Coriolis recoil-force amplifier, and the reaction to the Coriolis recoil force within a system rotating at a constant rate is well-established physics. However, the lack of a way for achieving highly directional Coriolis recoil forces has shielded these physics from practical applications.

One Coriolis-force bulk-mass flow measurement and control system, produced by Brabender Technologie, is identified by the name Fahlenbach in the references. The Brabender system uses straight rotating fins to pump dry bulk materials using the centrifugal forces from the rotating fins to supply the pumping action. The Brabender implementation also uses a gravity feed to uniformly drop powdered bulk materials onto a set of straight spinning fins, and the mass loading in this system is uniformly distributed across the total rotating disc. This implementation reduces the total system Coriolis forces by up to three orders of magnitude over those forces produced by the asymmetrical injection of fluids one fin at a time. The design of the Brabender system minimizes Coriolis forces. By way of contrast, the embodiments of the present invention are intended to maximize Coriolis forces within the system. It is the reaction to the integrated and maximized Coriolis forces that produce propulsion. Consequently, the commercial and symmetrical rotating fin Coriolis system is not able to achieve propulsion, because all Coriolis forces in the system only produce torques.

There are also no functional propulsion systems that conserve propulsion mass. Some systems that have been patented purport to conserve mass. However, these do not actually use mass for propulsion. Instead, the systems shift internal bulk masses to shift the center of mass of the system dynamically. As a class, these propulsion systems are called reactionless. Regardless, these systems do not exhibit useful propulsion and the physics is not explained, is not accurate, and is not correct. A more recent thruster invented by Roger J. Shawyer and called the Q-drive has been tested by NASA amid considerable controversy, since the test results have not been definitive. The Q-drive uses internal microwaves to produce thrust and no radiation or matter is ejected from the system. However, the physics of the process is not defined. The universal lack of testable systems and identification of legitimate physics makes the prior inventions suspect in all regards. The preferred embodiment of the present invention develops useful propulsion and is specifically designed to allow for recirculation of the propulsion mass so that the propulsion mass is not consumed or expelled in any manner in producing propulsion.

The present invention is not reactionless, as it does have an internal reaction. It is also non-inertial and non-linear as contrasted with rockets and jets, which are linear inertial propulsion systems that do eject the propulsion mass. Even though rockets and jets experience an acceleration, the instantaneous reference frame on the rocket or jet does not accelerate and is, therefore, inertial. Consequently, there is some lack of clarity when some motions are simply referred to as inertial or reactionless.

No non-magnetic propulsion systems that conserve propulsion mass are known to the inventor. Even with a propeller, whether on a ship or aircraft, mass is not conserved but is ingested, energy is applied, and the mass is ejected, thereby supplying inertial and linear propulsion. With linear motors or magnetic levitation propulsion, motion is constrained by the mechanization of these propulsion approaches, but there is still a force between the motor and a stationary and anchored surface to push or pull against. In the present invention, the propulsion is not externally constrained and is not pushing or pulling against something external and acts like rockets or jet engines in producing propulsion but without the concomitant ejection of mass.

A key component in the present invention can also function as a pump or mass driver. However, it is understood (and will be explained) that conventional pumps cannot be configured to produce linear propulsion. Consequently, the present invention must be contrasted with conventional pumping technologies to show that there is only a superficial resemblance between the present invention and the current art in pumps and pumping fluids in closed recirculation systems.

From a subsystem perspective, the first centrifugal pump, developed by Denis Papin in 1687, used a simple arrangement of two straight crossed fins as an impeller (two straight fins mounted on a spinning disc). In Papin's pump, the impeller was encased in a closed volute and fluids were pulled into the pump from an opening on the axis and were uniformly incident on the central area of the finned impeller. These fluids were centrifugally accelerated out to the tips of the fins and then into the volute casing and are pushed under pressure to the output orifice of the pump. Papin's design was inefficient and constrained by the then-unknown Coriolis forces. The Brabender mass flow control and measurement system is similar in design to the impeller on Papin's pump, though the Brabender system uses many more fins and does not employ a volute to constrain the flow of the mass being pumped.

Papin's design was replaced in 1851 by John Appold's design incorporating curved vanes that employed the Bernoulli effect of fluids flowing across a curved surface to create partial pressures. Note that once the fins of Papin's design became curved, they are referred in modern terminology as vanes. Appold's design proved to be about three times as efficient as Papin's design in pumping unit mass of fluids. Appold's design is the origin of all modern centrifugal pumps, and many designs and configurations have been developed for a variety of applications. All centrifugal pumps pull fluids in through an opening on the axis using the partial pressures developed within the pump by the spinning curved-vane impellers. The ingested fluids are uniformly distributed across all the spinning curved vanes of the impeller within the pump, which reduces Coriolis forces, as does the curvature of the impeller vanes, which improves the efficiency of these pumps by reducing power requirements in pumping unit quantities of fluids.

In the post-World War II period, many new flow-control and measurement systems were developed, some using the Coriolis forces to produce vibrations that are related to flow rates of materials, but only the Brabender system used the straight-spinning straight-vane or straight-fin configuration. Nearly all Coriolis-force mass-flow measuring systems use the vibrating tube implementations, such as that described in U.S. Pat. No. 5,275,061 by Young. Some use a rotating propeller within a flowing fluid, which use the Bernoulli effect to cause the propeller to spin. In addition, modern control systems are used to keep the rotation rates of many rotating system constant for certain measurement and control configurations. Motors supply the power needed to counter the torques produced by the Coriolis forces originating from the flowing material, and the measurement systems monitor the amount of power needed to keep the rotation rate constant. For systems in which no feedback control to the motors is used, these systems merely monitor flow rates and from these deduce the mass flow of a fluid or fluid-like materials such as powders or granules of solids. Other systems use the frequency of the applied electrical energy to the motors to force the motors to spin at constant rates. In these systems, any loads in the system are countered by the automatic electrical demands of the motor for more power to maintain constant rotation rates, and this power demand is monitored in determined fluid flow rates.

In the present invention, a fluid is injected radially onto the fins, one fin at a time and at one angular location. For a constant rotation rate, the output angular locations and fluid velocities are also all the same for each fin. Therefore, when fluids are injected axially onto a fin near the rotation axis, the mass is accelerated out to the end of the fin and exits the spinning disc with a fixed radial output velocity component. When mass is injected onto a fin at a velocity at the outer rim of the spinning disc, the injected mass element is centrifugally slowed or retarded and exits the fin near the axis with a low velocity component. However, as will be demonstrated, these are dynamically mirror image or reciprocal systems. Furthermore, no such discrete mass injection implementations are known to have been incorporated into rotating systems using such arrangement of fins.

In addition, the axial injection location results in a pumping or mass driver functionality that is unique. The fluid is preferably injected in discrete pulses, since a continuous stream of fluid that is “chopped” as each fin passes through the stream results in splashing. This may adversely impact system integrity and consistent operation. Discrete injection ensures that a specific quantity of mass is cleanly introduced onto each fin at a precise time. When the injection location is at the outer rim, the velocity retardation of the injected mass is also a unique implementation. Each reciprocal implementation for the injectors produces similar magnitude of the integrated Coriolis recoil force and driver motor power requirements. In addition, the magnitude of the resulting integrated Coriolis force is orders of magnitude larger than the Coriolis forces produced in symmetrical rotating finned system for both fluid injection approaches. Therefore, the rotating finned disc amplifies the integrated net system Coriolis force, which is believed to be heretofore unknown.

Some components of the preferred overall system may use standard industrial technologies, e.g., the fluid injection including pumping the recirculating propulsion mass, and the functioning of these components and subsystems is well known to the industrial arts. The arrangement, configuration, and operation of the present invention is believed to be unique, even with existing equipment being used.

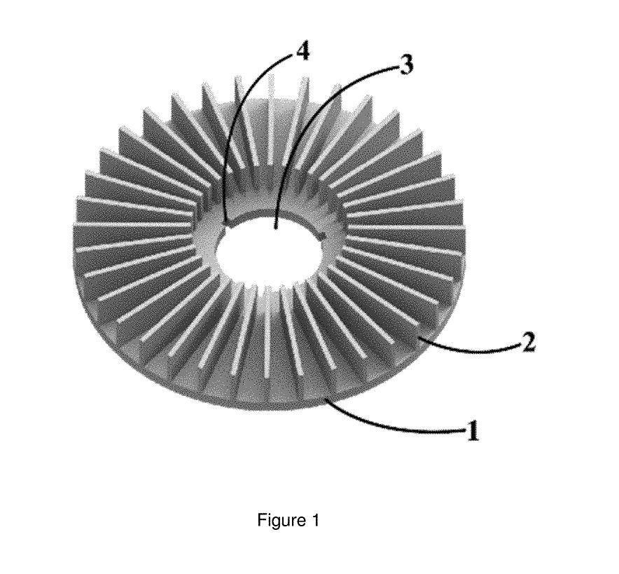

FIGS. 1 through 6 represent various elements of a preferred embodiment of the present invention. It is believed that the propulsion system is subject to being scaled continuously to meet the requirements of an application. The dimensions and characteristics of the various elements of the system are driven by the mathematical models and empirical results used to design any given instance of a propulsion system, as described in more detail below. As the system is scaled, the fluid flow dynamics will change at the injectors, within the rotating vane subsystem, and within the mass capture and recirculation system. Furthermore, the actual length of the fins will depend on the requirements for the fluid capture and recycling system, which may be empirically determined. While the preferred embodiment is for spinning fins with injectors at the outer rim of the spinning disc, there may be for certain embodiments a requirement to replace the vanes with hollow tubes of some preferred cross section, although that system is not detailed here. The totality of the critical subsystem will use spinning discs with fins (or tubes) plus discrete injection of fluid mass and a fluid recapture mechanism. The drawings show the preferred implementation in which mass is injected radially at high speed onto the fins at the outside end of the fins, and this approach has many mechanical advantages over an alternative design that is also described.

The present invention has two basic embodiments of the present invention, each of which is based on a disc 10, as depicted in top perspective view in FIG. 1. In both aspects, the disc 10 has a planar base 11, provided with a plurality of vanes 12 that extend between a central opening 14 of the disc to an outer circumference 16 thereof. Means 18 for attaching the disc 10 to a shaft for rotation is provided around the central opening 14. As depicted, the means 18 is a plurality of slots for engaging a similar plurality of keys on the shaft. Other means 18 for attaching the disc 10 to the shaft would be known to those of skill in the art. In a preferred manner of attaching the disc 10 to the shaft, the means 18 will allows a small standoff gap to be maintained between a rim of the central opening and the shaft, permitting greater dynamic operational flexibility for the system, as will be explained.

The fins 12 are arranged symmetrically around the circumference of the disc 10 and extend radially from an inner end near the central opening 14 to the outer circumference 16. The fins 12 can be mounted on the base 11 or formed integrally therewith. Preferably, the disc 10 has fins 12 on only one of the planar surfaces of the base 11. Also, the spacing of the inner end of each vane 12 from the central opening 14 can be used to accommodate the hydrodynamics necessary for efficient fluid capture and recycling.

This embodiment of the disc 10 depicted in FIG. 1 can be called a retarder. This aspect of the disc 10 receives fluid injected at high velocity at the outer circumference 16 of the disc as it spins and the injected-fluid velocity is retarded as the fluid moves radially inward. In the other aspect, the fluid is injected at the central opening 14 and is accelerated as it moves radially outward, so the disc in that aspect can be called an expeller. The net integrated Coriolis force magnitudes are similar in magnitude and direction in both implementations, and the integrated Coriolis forces are what produce propulsive forces. However, the mechanical implementation of the fluid injection and recapture and recycling system are much more complicated and may be prohibitively complex when the fluids are injected near the central opening 14 rather than at the outer circumference 16. Consequently, the description provided here is for the preferred embodiment in which fluids are discretely injected into the outer end of the spinning fins onto each fin one fin at a time. Furthermore, the fins could be replaced by tubes of some cross section, but the physics would still be for the injected fluids to be entrained on the inner surface of the tube as this fluid would be entrained on the surface of a fin on a disc. As will be seen, when the discs 10 are stacked along a shaft, the bottom surface of each disc 10 operates as a top for each of the open channels created by the fins 12, effectively defining a plurality of closed conduits of rectangular cross section, albeit a cross section that decreases as one moves radially inward along the conduit. Replacing these closed conduits with tubes only changes the cross-sectional profile from rectangular to another shape, which-allows the cross-sectional area to be modified.

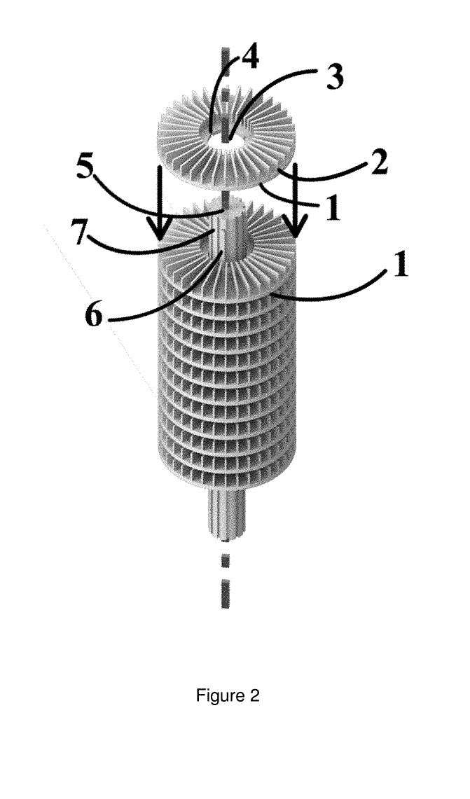

The concept of stacking a plurality of the discs 10 on a shaft 20 is depicted in a perspective view in FIG. 2. Shaft 20 is driven at one end thereof by a source of rotational power provided by a source such as a turbine or motor. In some very advantageous embodiments of the invention, this turbine or motor will be powered by a solar or nuclear power plant. The shaft 20 will be arranged to spin within at an operational rate and preferably to spin within a range of operational rates. It is important to note at this point that the power source that spins the shaft 20, as well as the stacked discs 10 on the shaft 20, operate at less than 100% efficiency, so the invention is, by no means, to be considered as violative of the laws of thermodynamics.

As shown in FIG. 2, each disc 10 in the plurality of discs is locked to the shaft 20 for rotation at the same rate thereabout. In most aspects of the invention, it is anticipated that conventional means for locking the discs 10 to the shaft 20, such as mating keys and keyways, would be employed. Under such a technique, each disc 10 can be sequentially slid onto shaft 20 and locked into place, or unlocked and slid off of the shaft, as needed. Although FIG. 2 shows an arrangement using three linear keys 22, one of skill will immediately recognize that much variation may be employed to provide the assembly 100 of discs 10 on shaft 20 as shown. For example, a plurality of keys 22 could be arranged to spiral around the shaft 20 for mechanical and hydrodynamic purposes. While the alignment of the fins 12 as depicted in FIG. 2 is clearly preferred, it will not be mandatory for proper operation.

The fins 12 of the spinning discs 10 do not produce a pressure such as those produced within a typical pumping configuration by the spinning impeller inside of a pump. However, this is not to say that the plurality of discs 10 could not be arranged to function in a pumping configuration for specialized applications.

The exact number of discs 10 in each assembly 100, and, in fact, the number of assemblies necessary to implement the inventive concept will be clear to those of skill, once the manner and purpose of assembling each assembly 100 is understood.

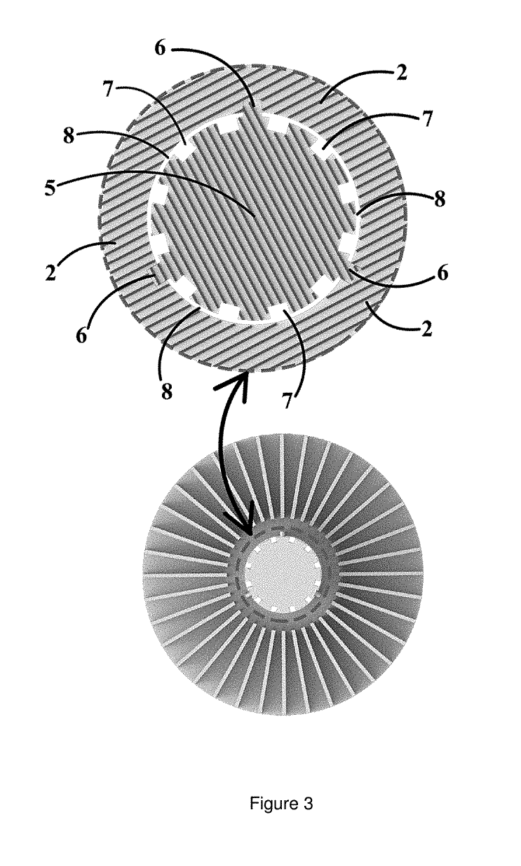

FIG. 3 depicts a cross-section of the engagement of a disc 10 with the shaft 20, and particularly there is an enlargement of the inner portion (radially inward from the fins) of the disc 10 and the shaft 20. In the enlarged portion, there are three keys 22 of the shaft 20 that are fitted into slots 18 of the disc 10. Open areas 24 and 26 of the shaft 20 provide flow conduits for collecting fluid that has been injected at the outer circumference of the disc 10 and retarded in velocity as it approaches the shaft. Each array in a pair spins opposite the other array in the pair to counter recoil torques in the motors or turbines driving the arrays. In addition, the linear injector row is selected, so that the integrated Coriolis recoil forces from the counter-rotating arrays are colinear, which is one reason why the linear injector rows or arrays are angularly spaced around the retarder array. Therefore, the recoil vectors can always be aligned. Also, the retarders are stacked in contact on shaft 20, so that the base of one disc supplies a cap on the adjacent set of fins, thereby creating a tube-like arrangement of rectangular cross section that would confine the fluids dynamically to a single channel and eliminate “leakage” of working fluids out of the arrays.

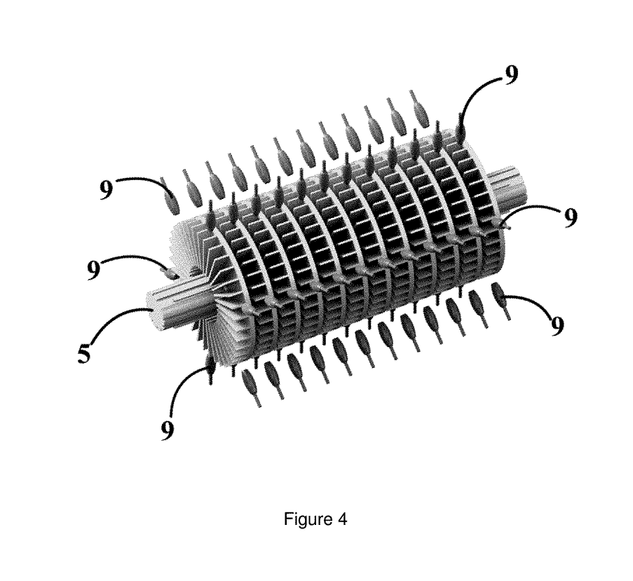

FIG. 4 is a perspective view of an assembly 100 arranged for operation. The inventive effect of the device is achieved by injecting a fluid, in a particular discrete manner, into the assembly 100, so that the action of the assembly on the fluid results in Coriolis recoil forces. In the depicted embodiment, there are a plurality of linear parallel arrays or rows 30 of injectors. Each row 30 comprises a plurality of fluid injector nozzles 32 and each of these nozzles 32 is plumbed conventionally to a pressurized source of the fluid. The rows 30 are mounted in parallel sets along the outer rim of the assembly 100 and are preferably symmetrically arranged angularly. As discussed later, this is the preferred location of the injectors. Not shown are support structures upon which the injector arrays and the array shafts are mounted. Also, not shown are the cradle bearings and end seals upon which the rotating shaft is mounted nor are the recirculation pumps shown which carry the fluid from the channels in the shaft back to the injectors.

Each disc 10 of the assembly 100 is provided with a corresponding injector nozzle 32. The injector nozzles 32 are arranged to supply a timed, non-continuous stream of the fluid in precisely timed pulses. A number of techniques are known in the art for breaking a fluid into such a pulsed stream, such as the devices known and used in vehicle fluid injectors and the devices used to prill molten materials, such as urea for agricultural use, into regular, spherical solids. Of course, in the present use, the intention is only to create discrete pulses, not to vaporize or to solidify the fluid. In a zero-gravity application of the invention, the proper nozzle technology will craft the fluid into compact, highly-spherical globes of fluid before the entry of the fluid into the opening on the finned disc 10 at which it is directed. By providing a plurality of the arrays 30, the angular location of the injected fluids can be altered to allow redirection of the system recoil, which allows for changes in direction of the propulsive forces in two dimensions.

In operative use, a collection of assemblies 100 would have their respective shafts 20 arranged in parallel and driven at the same rotation rate from a common turbine or sets of turbines or motors that may or not be synchronized. Multiple arrays could be required for mechanical purposes related to injector functioning, fin mechanical constraints, and the total forces present on a single shaft, plus the arrays of discs and multiple arrays can allow the system to perform more smoothly. It is necessary that the arrays all rotate at the same rate. Pairs of arrays would rotate counter to each other, to eliminate certain rotational pitch torques on the overall system. The amount of fluid injected at each vane would be determined by both the required system performance and the optimum performance of the injectors. The number of rows of injectors would depend on the design requirements for the system. The injector arrangement also ensures that the injected fluids are being injected at the same relative location on all expellers.

The injector requirements in terms of placement and quantities of fluids injected at high velocity into the vanes are also driven by the integrated forces that are experienced and the mechanics of the system for handling significant forces on the common spin shafts 20 and on the vanes 12. For instance, if 1 kg of fluid is used per second for total propulsion requirements, then the injector specifications determine the quantity of mass supplied at the requisite injection velocity and pulse repetition rate for providing the required quantity of mass injected into each fin in one second. To meet the system performance goals, for example, if 100 discs with 50 fins each are to be supplied, each injector would need supply 500 pulses per revolution for the given array. If the spin rate of the shaft is 10 revolutions per second, then the injectors would supply 5000 pulses per second, each pulse delivering 0.2 gm of fluid. This quantity of fluid would supply integrated recoil forces on the common spin shaft, the forces arising from Coriolis forces on the fins, all of which would need to meet long-term system reliability requirements.

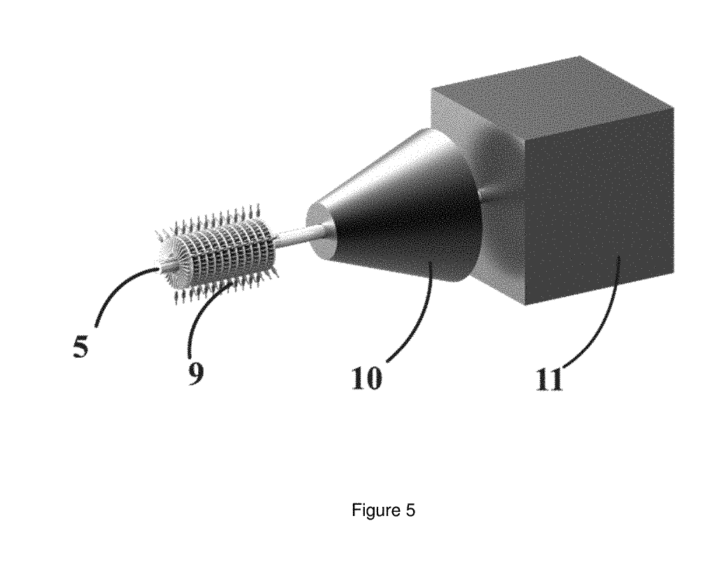

FIG. 5 schematically depicts an assembly 100, equipped with fluid injector rows 30, with the shaft 20 of the assembly operatively engaged with a generic turbine T that is receiving power from a generic power source P. In practice, counter-rotating array pairs, where each array is as shown in FIG. 4, would be driven by an arrangement of gears, chains, or belts to allow one turbine or motor to drive many such array pairs. No controller or feedback electronics are indicated, though such controllers are common to modern industrial and aerospace arts. Only the unique mechanical elements of the invention are depicted in detail. As noted previously, power source P would typically be a thermal source, such as a nuclear reactor. If the turbine T is replaced by an electrical motor, the power source P could also be a solar or nuclear isotope source. For the motor, any power source P would be associated with subsystems that generate the required electrical power to drive the motor. For instance, a thermal nuclear isotope source would require a subsystem to convert the thermal power to electrical power which is then used to drive the motor that is driving shaft 20. Alternately, the turbine T would be driven by hot gases and directly drive all shafts 20.

For certain applications, all elements in FIG. 5 could be part of a self-contained module, which would produce propulsion. For certain applications, many such modules as depicted in FIG. 5 could be clustered to provide addition levels of propulsion to a system. For low powered space applications, power source P could be an array of photovoltaic cells for receiving light energy and the motor and retarder array would be a separate compact self-contained module. This disclosure does not include designs associated with motors or turbines and power sources, but the inclusion of some or all these subsystems into a self-contained propulsion module is part of this disclosure. Furthermore, for certain implementations, control modules would be part of the integrated system. As propulsion modules are clustered to achieve greater propulsive forces, some master control system would coordinate the operation of all propulsion modules. This is consistent with current practices in aerospace implementations in which multiple propulsive units, such as jet engines, operated in unison, where embedded controller modules in each engine perform subordinate control functions for that engine based on master controller commands as well as the discrete requirements determined by sensors within each engine that control and monitor the state of the engine.

The mechanical implementation of the assemblies 100 would be consistent with known arts associated with the use of motors or turbines to drive various machinery. Therefore, the seals, bearings, and connecting mechanisms are expected to use current arts with specific variations appropriate to the operation of that arrays in all environments, from atmospheric to space and from wet to dry conditions. For space applications, the additional requirement for sealing the total module would use standard aerospace techniques and technologies. Furthermore, the propulsion fluids would be recycled in a closed system within the propulsion module.

The specific dimensions of the components and subsystems shown in the figures are defined by the application. The diameter, height, thickness, length, and radial positioning of the fins 12 depend on the required net system thrust plus recycling requirements, which further defines the size and robustness of the assembly 100 for any given application as well as defining the diameter and cradle bearing number and location that supports the spinning shaft 20. The major design issue is how mass is injected and recirculated and how fast the assembly 100 rotates. The number of fins is also a matter of design requirements, including physical durability of the fins and injectors. Therefore, the diameter of the discs 10 can be anywhere from 10-15 cm up to many meters, and the diameter and bearing support for the shaft 20 also depends on the forces that the shaft will experience. The size of the power source also depends on applications, which also determines whether motors or thermally driven turbines are used to spin the arrays. Taken together, the size and mass of a power source and the size and robustness of the arrays determine the overall physical size of a propulsion module. Such scaling is common in developing diesel engines to power various vehicles from automobiles to ocean cargo craft or warships.

With the exceptions of possible custom designs for the fins, the rest of the propulsion system uses known technologies of broad commercial success. In fact, the mechanical and electromechanical technologies parallel those of automotive and aerospace technologies, which are well established, robust, and amenable to any necessary modifications for specific applications. These standard technologies include but are not limited to the electromechanical subsystems and turbines for nuclear power systems and the controls and turbo-pumps or Brayton-cycle turbines and other electro-mechanical subsystems and controls used in rockets or jet aircraft. In addition, the input to each fin is via discretely injected jets of fluid using well-developed injector nozzle metering and input technologies adapted to the high rates of input for the specific applications.

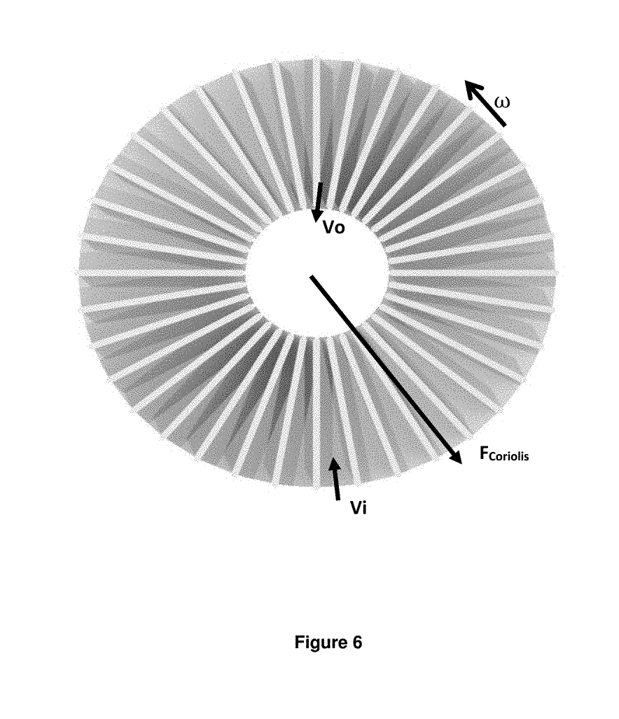

FIG. 6 schematically depicts how a preferred embodiment of an individual disc 10 produces non-linear momenta. Mass is injected one fin at a time as the rotor spins at angular rate ω. Mass, in the form of the selected fluid, is input discretely to all fins at high speed Vi at the same angular location, and the output to the retarded mass is at the inner core of the spinning fins, all at the same angular location and all with the same retarded output velocity Vo. For a unit mass, the change in velocity at the injection point and the output location produces a reaction force given by the mass times the change in velocity, Vi-Vo, where Vo is also the change in velocity as the mass is recaptured for recirculation. The net integrated Coriolis force is orders of magnitude greater than and non-linear to the input and output mass recoil forces.

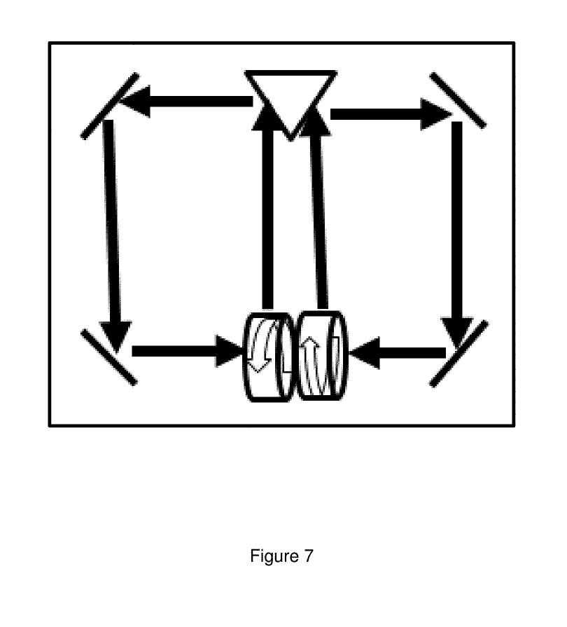

FIG. 7 is a schematic view of the fluid flow and momentum paths in a typical conventional closed-cycle circulation system in which back-to-back counter-rotating pumps eliminate motor torques that would produce angular pitch into the plane of the figure. Such a system can produce torques but not linear forces, which is why typical pumps cannot be used in a closed system to create linear propulsion but can produce rotations.

### Background to the Actual Physics

Consider the following description based on a rotating carousel. A ridged and well anchored hollow tube spans the range from near the center of the carousel to the outer rim of the carousel. A spherical object inserted into the hollow tube at the center-end of the tube will experience a centrifugal force accelerating the sphere toward the outer rim of the carousel. In addition, the tube will experience a force on the side of the tube opposite the direction of rotation of the carousel. The force on the tube results from the tube pushing on the sphere, which is the root source of the centrifugal acceleration. Without the tube wall pushing on the sphere, there would be no centrifugal acceleration. The force causing centrifugal motion acts orthogonal to the motion itself and is one-half the magnitude of the Coriolis force. However, the force of the tube on the sphere creates an equal and opposite force on the tube wall and this is the Coriolis force. The Coriolis force acts to slow down the carousel's rotation, which is a consequence of the conservation of momentum. This is well-known physics.

There is another element of physics, also known but not previously applied to such a rotating system as described by the carousel scenario. In a paper by Dudley and Serno, the motion of a space ship with a thruster mounted to the side of the space craft cylindrical body and pointed perpendicular to the centerline of the craft is modelled. The thruster therefore produces rotation of the craft about the center line of the craft. But this same thruster also causes the center of mass of the spacecraft system to move in a spiral path as if there is also a continuously varying force acting through the center of mass of the craft.

The above behavior for an arbitrarily-directed force to appear to act through the center of mass is known to space engineers as they configure space work robots or working methods for astronauts. The physics is that, for example, if a robot arm contacts a heavy object elastically or rigidly and if the robot is not firmly anchored, the whole robot rebounds from the contact with both a rotational and linear translational motion. The rotation is determined by the lever arm between the robot arm contact-point distance from the center of mass of the robot. The rotation rate and the linear recoil are both determined by the contact lever arm length and the size of the contact force. These principles are discussed in an article by Nenchev and Yoshida.

There is other well-known physics which reinforces the above descriptions and which is taught in almost all undergraduate analytical mechanics courses. It discusses the motion of an object struck by a force or impulse that is not directed at the center of mass of the object. This physics is used to describe the space robot scenario discussed above. Typically, the physics is discussed for a linear object laying on a frictionless surface, such as ice. If the object is kicked at one end, we can describe mathematically how the object rebounds. The object rebounds by both spinning and translating, just as with the space robot. If the spin caused by the torque associated with the impulse magnitude and location relative to the center of mass of the object is suppressed by some counter torque system, the total motion is linear and has magnitude as if the impulse was delivered at the center of mass of the object regardless of where on the object the impulse was delivered. Analysis of such physics can be found in the undergraduate analytical mechanics texts.

### Physics and Design for the Expeller and Retarder Subsystem

Recall that there are two embodiments described here, the so-called “expeller” model, in which the injected mass moves radially out, and the so-called “retarder” model, in which the injected mass moves radially in. The expeller model is described, because its modeling is more obvious and supplies the same types of Coriolis recoil forces as for the retarder models, but the retarder model is less intuitive to understand. The dynamic behavior of an accelerated mass is nearly the same as for the retarded mass in the retarder configuration, and the dynamics is symmetrical between the expeller and retarder. The integrated Coriolis recoil force magnitudes are similar but not the same for both configuration, and the resultant net recoil force directions must be independently calculated between the two configurations. The differences between the two embodiments occur because mechanically the injection and exit velocity of the propulsive mass differ because of the requirements of the capture and recycling system for each embodiment. From a practical perspective, a retarder injection velocity must be larger than the expeller's radial output velocity to supply sufficient fluid flow at the shaft to enable efficient recycling pressures and volumes for the recycling pumps.

The expeller design is an extrapolation of the carousel scenario developed previously. The fins replace an angular array of equally spaced radial tubes that span the distance from near the center of the carousel or disc out to the periphery of the disc. The number of fins is determined by physical constraints associated with packing density of tubes as well as with the overall physical design. A fluid such as water, though not necessarily limited to water, when input near the center of the disc at each fin, follows a spiral path as viewed from outside as the droplets of fluid are centrifugally accelerated toward the outer end of each fin. If the droplets are injected at each fin at the same radial velocity and at the same angular location, then the droplets all follow the same spiral path and exit the expeller as a narrow stream of droplets, all moving with the same speed and direction. If the droplet stream is collected, the droplets can be recycled back to the injectors that input the droplets in the first place. It is noted that if a fluid having a higher density than water is available for use, such as ferrofluid, the higher mass of a droplet can enhance the effect obtained.

As each droplet is accelerated by the centrifugal forces, a Coriolis force is pushing on the fin at each instantaneous location of the droplet. A motor or turbine driving the rotation of the expeller maintains the rotation rate constant as the torque on the fin changes because the radial distance of the droplet from the center of rotation is changing, and the magnitude of the Coriolis force is also changing as the distance along the fin is changing, where the Coriolis force is always perpendicular to the fin at the instantaneous location of the centrifugally accelerated mass. From the prior discussion, since the motor is dynamically countering the torque on the fin, the reaction of the expeller from the Coriolis force acts through the center of mass of the expeller, which is where the drive shaft is located. The integrated recoil force is determined by integrating all the instantaneous Coriolis forces along a single fin and adding all the recoil for all the fins over a unit time. Therefore, the summing is over the number of fins in an expeller times the number of rotations of the expeller per second. If there are an array of expeller discs on a single drive shaft, the recoil from a single expeller disc is multiplied by the total number of expellers.

The integrated Coriolis forces on a single fin can be modelled by modeling the dynamics of the centrifugally accelerated mass using the Euler-Lagrange equation. Using this approach, it is possible to mathematically define the path and instantaneous location and speed of a mass element as that mass element or droplet travels from the input location out to the end of a fin. From these models, the instantaneous Coriolis force on a fin is determined. Once the instantaneous Coriolis force on a fin is known, the integrated Coriolis recoil force on the expeller drive shaft is determinable. There is also a recoil force from the injectors as each pulse of mass is input onto a fin, and we must also account for the recoil from the exit mass as it impacts a collection subsystem. The recoil forces from the input, output, and Coriolis recoil are as symbolically depicted in FIG. 6 for the retarder configuration. From the models that are developed, the net Coriolis recoil force is found to be over 100 times the recoil associated with both the input injector and the impact of the output mass with a collection target. The input velocity of the injected mass represents an acceleration of the mass from nearly zero speed to some injection speed. Therefore, a mass m subjected to change in velocity is a change in momentum, which is a force. When the output mass is slowed abruptly to zero velocity at a collector after being accelerated in the expeller configuration, there is another change in velocity, which is a change in momentum and, therefore, also a force. Thus, each arrow in FIG. 6 represents a force on a unit mass. These forces are unequal in magnitude and direction, with the Coriolis recoil force orders of magnitude larger than the other recoil forces.

For the rest of the momenta changes in a total recycling system, consider FIG. 7, which depicts a standard closed cycle pumping system mounted within a closed container, where two centrifugal pumps are mounted back to back. In this case, the torques associated with the rotation of the pumps cancel and eliminate any angular pitch in the system. In the figure, the arrows represent fluid flow paths and the momentum associated with that fluid flow. Where the arrows change direction, there is a change of momentum of the fluid, which produces a force on the surface causing the change of direction, which is a result of the conservation of momentum and Newton's linear laws of motion. Any unequal path lengths also can produce uncompensated torques on a system, and these uncompensated torques produce a yaw or rotation in the plane of the system. Consequently, uncompensated torques within such a system creates the conditions for pitch and yaw angular motions. Such motions are how and why gyroscopic stabilization systems on ships can be used to compensate rotational torques or can be used to create rotational motion in satellites, though these particular systems typically only employ the recoil associated with spinning masses.

In the system shown in FIG. 7, not only does the pump spin create a torque, the output of the pump creates a linear recoil on the pump. If a pump is not properly anchored or constrained, it can exhibit rotational and linear recoil motion until it reaches some physical constraint, such as a wall, but if the pumps are anchored and the system is closed so that fluids are recirculated, all linear motion is compensated, and only rotational motion can occur. All the forces and torques cancel in a such a system and no uncompensated linear motion occurs for any such system, though any unbalanced lever arms can introduce rotations in the system. What we see is that the expeller or retarder breaks this symmetry and creates the opportunity of an uncompensated linear recoil, which is the integrated Coriolis recoil on the center of mass of the system.

It is qualitatively seen that by replacing the pumps in FIG. 7 with the retarder or expeller, a net non-linear recoil force is placed on the center of mass of the system. All momenta changes in the system cancel until the expellers are reached. If all flow friction and resistance within the system is reduced, for the expeller configuration, the output (up arrow out of the pumps) has some velocity Vo which is circulated back to the input of the counter-rotating expeller pair and the velocity is slowed to Vi at the expeller input. However, the force associated with the momentum change in the fluid circuit results in a net force within the system. But the directions of Vi and Vo are not aligned and are orders of magnitude smaller than the Coriolis recoil force, which is itself not aligned with either Vi or Vo except by design or accidentally, and consequently we are left with a system in which any residual force associated with the input and output recoil forces are small perturbations on the much larger and uncompensated Coriolis recoil force.

It is worthwhile looking at FIG. 7 in more detail. The output stream of the two expellers strike a wedge shown at the top of the figure and the streams are split or redirected horizontally to the deflectors shown in the corners of the figure. This is a recycling system that is symmetrical, which avoids any unbalanced momenta in the system that would produce yaw or sideways angular momenta in the system. This configuration also brings the fluids back to the input ports of the pumps. The key point is that the wedge is an inelastic target in that the linear momenta that the stream of water exchanges with the surface upon which the wedge is mounted does not rebound back toward the pumps but is diverted at right angles into two opposite streams whose momenta cancel. Careful addition of the momenta exchanges with all surfaces in either half of the two re-cycling paths show that all momenta exchanges with the surfaces are canceled leaving no net linear momenta in the system. Hence, such a system using conventional pumps cannot produce propulsion. However, by replacing the centrifugal pumps in FIG. 7 by expellers breaks the symmetry indicated in FIG. 7 and allows the closed system to produce a net linear momentum and force, which we have shown acts through the center of mass of the expeller. Even by confining the analysis to one half of the system, we are left with a pitch into the plane of the system as the only uncompensated torque or linear force.

The trajectory of the mass inserted near the axis of the rotating radial expeller fins, such as those indicated in FIG. 7, can be modeled using the Euler-Lagrange equations using the kinetic energy of a mass element in the angular and radial directions. Friction and any other non-conservative force acting on the mass may be included. Setting up the dynamic models, the scenario in which the rotation rate is kept constant as well as the scenario in which the spinning disc is given an initial rotation rate and then allowed to free-wheel by removing the driving motor spinning the disc can be modelled. In this latter case, the conservation of momentum applies and, as the mass moves radially outward, the rotation rate slows, though this latter scenario is not useful in modeling the present invention. The rotation rate has to be constant so that the Coriolis recoil on the fins can be manifest as a recoil force on the center of mass of the rotating system, which is a location within the spin axis. In an array of retarders, the recoil for each is within the rotation shaft, so that for the array, the recoil forces are distributed along the length of the drive shaft.

The approach to the modeling is to find the Lagrangian for the expeller subsystem's dynamics in polar coordinates and then to find the equations of motion using the Euler-Lagrange equation. The problem is like that for finding the motion of a bead sliding on a wire as the wire is rotating at a constant rate about a fixed pivot point at one end, much as a radial spoke in a bicycle wheel rotates as the wheel turns. The resultant centrifugal force as the wheel rotates accelerates the bead radially outward along the spoke. Using the Euler-Lagrange equation, we can find the instantaneous radial and angular location of the accelerated mass and the concomitant radial velocity of the mass at each radial position. The instantaneous Coriolis recoil on the fins depends on the instantaneous radial position of the mass. Using typical vector decompositions of the instantaneous Coriolis recoil vector relative to the starting angular position of a fin as the mass in first injected with velocity Vi at position Ri, we find the independent x-y components of the recoil Coriolis vector as a function of the fin's rotation angle out to the position at which the mass leaves the fin. By integrating the instantaneous Coriolis vector components over the full rotation angle, we find the net x-y values of the components and the direction at which the total net recoil vector points relative to the initial position. This net integrated recoil vector is the force supplying propulsion on the rotation drive shaft for the retarder or expeller arrays. For a retarder array, the magnitude of the integrated recoil vector is the same as for the expeller array within the limits discussed previously.

The solutions that were found from the Euler-Lagrange equation holding the rotation rate constant are:

r(t)˜Ri Cosh[ω t]+Vᵢ Sinh[ω t]/ω,

with exit velocity components

V_{θ}=R ω and Vᵣ=Rᵢ ω Sinh[ω Tₑₓᵢₜ]+Vᵢ Cosh[ω Tₑₓᵢₜ],
where
r(t) is the radial location of the accelerated mass as a function of time,
t is time, ω is the rotation rate in radians per second,
ω t=θ is the angle through which rotation occurs in a time t,
Tₑₓᵢₜ is the time for the mass to be accelerated out to the tip of an expeller fin,
R is the full radius of the expeller fin,
Vi is the initial radial injection speed of the mass element
Ri is the initial radial location at which the mass element is inject onto a fin,
ω Tₑₓᵢₜ is the full angle through which the expeller rotates before the mass is ejected.

Solving r(t) for the time for the mass to reach R supplies Tₑₓᵢₜ. The vector sum of the two velocity components, V_{θ}and Vᵣ, define the output direction or angle and the output speed. However, for the retarder configuration, V_{θ} can be ignored. Also, ω t=θ and ω tₑₓᵢₜ=θₘₐₓ. As solved, r(t)≡r(θ).

The resulting equation for r(t) or r(θ) can be used to find the path and exit velocity for inputting a mass at the rim at Rₘₐₓ with some initial radial velocity Vᵢ=−Vₑₓᵢₜ=−Vᵣ, which was found by performing the modeling described above when the mass was introduced into the system at location Rᵢ. Note that we are only using the radial velocity component in finding the input velocity at the outer rim of the expeller. The resulting curve for injecting the fluid at the outer rim is an inward spiral. Therefore, the equations of motion and position can be used for either the expeller or retarder configuration. There are system design benefits to one or the other of these two implementations of the expeller, since the magnitude of the integrated Coriolis force is nominally the same for both configurations, though the direction of the resultant integrated Coriolis force will be different relative to the angular position of the injector.

The magnitude of the Coriolis force at any location on an expeller fin is given by:

f_{cori}=2m r ω²=2m ω²RᵢCosh[ω t]+2m ωVᵢSinh[ω t],

where m is the mass element that has been injected at some location identified as being θ=0. The Coriolis force is perpendicular to the fin. Since ω t=θ, the angle the expeller rotates through in time t, the Coriolis force is a function of the rotation angle. By resolving this vector into x-y components relative to the initial angular location noted as θ=0, we find the instantaneous components are

f_{cori-z}=f_{cori} sin θ,

f_{cori-y}=−f_{cori} cos θ.

Integrating these components over 0≤θ≤θₘₐₓ, the net Coriolis force components in the x and y directions is determined. From these components, the direction of the net integrated force supplying propulsion is found. The integrated propulsion vector is perpendicular to the drive shaft for an array of expellers or retarders. By changing location of the injected mass elements using the linear injector rows indicated in FIGS. 4 and 5, the direction of the resultant propulsion force can be rotated through 360 degrees to supply what amounts to thrust vectoring in a plane.

### Physics of the Propulsion System

Now the source of the propulsion is described. Consider an astronaut who is in a long narrow floating capsule and who has a heavy object such as a medicine ball. If the astronaut is close to one wall and pushes the medicine ball at the wall of the capsule, the astronaut recoils opposite the direction the ball was thrown. The effect of the ball hitting the near wall inelastically is for the momentum of the ball to be transferred to the wall and for the wall to rebound linearly. When the astronaut hits the rear wall of the capsule, his momentum will cause the capsule to rebound slightly, which cancels the initial momentum that the ball gives to the capsule. Therefore, the capsule will move in the direction of the medicine ball momentum until the astronaut strikes the rear wall and all motion stops. However, the capsule has moved slightly from its initial position.

This is, of course, a one-time event, since there is only one medicine ball and there is no recycling of the ball back to the astronaut. If the astronaut has two medicine balls and if after the astronaut hits the rear wall they throw the second ball at the far wall, the capsule will rebound opposite the direction the ball was thrown. In this case, the capsule reverses its movement until the second ball hits and sticks to the far wall, bring the capsule to a stop. The net effect is for the capsule to have returned to its initial starting location and to have no net motion. Further analysis including some recycling of the medicine balls will show that over time the net motion of the capsule is zero.

Now, consider the above scenario in which the astronaut does not rebound after throwing the ball. In this case, when the ball hits the wall, the capsule rebounds and is not brought to a stop. Propulsion has been produced. This example is limited, since even if the astronaut did not rebound, the rear wall of the capsule will eventually strike the astronaut in the back and stop any rebound of the capsule. However, we use the expeller to produce the effect of the astronaut not rebounding. Since the expeller would be anchored to the capsule, the capsule and expeller all rebound together. We have accelerated a mass and when that mass strikes the recycling target on the forward bulkhead, we transfer the linear momentum to the capsule. However, we also have a non-linear and much larger Coriolis force acting in another direction, which is the direction in which the capsule actually recoils. Consequently, the total momentum transferred to the “capsule” is the vector sum of three forces, which are the linear force as the momentum of the centrifugally accelerated mass hits the recycling system target or recapture system, the injector recoil, and the integrated Coriolis force. These vector actions produce a substantial net momentum, because the Coriolis forces is substantial and non-zero and is not cancelled by any other momenta or forces. We have, therefore, developed propulsion without expelling mass from the vehicle or “capsule.”

Once we have the instantaneous Coriolis force for a unit mass, we find the acceleration of that mass by dividing f_{cori}/m, where m is the unit mass. Then, since we have the Coriolis force for a unit mass from one expeller fin, we find the total mass per second by counting the fins per expeller times the rotation rate of the expeller times the total number of expellers in the system. This is, then, in one second, the mass throughput per second for all the expellers, which is called \dot{m}=dm/dt, which is the time rate of mass cycled through the retarder per second. Therefore, the system equation of motion is:

\dot{m}a_{Coriolis}=a_{system}Mₜₒₜₐₗ,
where
\dot{m} a_{Coriolis} is the Coriolis force,
a_{system} is the total system or vehicle acceleration, and
Mₜₒₜₐₗ is the complete system mass including the vehicle, cargo, and propulsion masses.

Consequently, the total acceleration of a vehicle is a_{system}=\dot{m}a_{cori}/Mₜₒₜₐₗ. Since the acceleration vectors add linearly, by resolving the Coriolis force into orthogonal components, we find a net direction and magnitude that is applied to the whole vehicle. From this we can model the total system dynamics, including the mass throughput requirements based on expeller design parameters and required system acceleration. From the performance requirement, we can find the power necessary to achieve the performance, which is discussed next.

The drive turbines or motors supply the torques needed to keep the expeller rotation rates constant for any mass throughput requirements. We alternately speak of motors or turbines, but a separate analysis shows that motors of any kind, electrical or mechanical, have limited power-to-mass ratios to be useful for certain scenarios. Therefore, the expellers must be driven by Brayton-cycle turbines driven by the thermal energy supplied by some source, perhaps a nuclear source. Jet engines are Brayton turbines, but the thermal energy and mass are expelled, which makes jet engines inapplicable to powering a closed system. However, in principle, the jet engine might be configured to be a part of a closed system and to play the role of the centrifugal pumps identified in FIG. 7. The net result is that the jet-engine subsystem would not supply any net momenta to the system but could power the expellers, and the expellers would supply the net thrust to the overall system. Such hybrid systems were not fully analyzed because their operation in outer space would have to be that for a rocket. Ultimately, the consumption of fuel and oxidizers would limit these hybrid systems to being functionally no different than using rockets alone in space or jets alone in the atmosphere. However, for atmospheric operation, the retarder system could be used to reduce or even eliminate thrust vectoring needed for vertical launching of aircraft or for maneuverability for certain mission or control requirements, including transitioning from vertical to horizontal or horizontal to vertical motion.

Also, since the Coriolis forces in the retarders are perpendicular to the retarder fins, they create torques that the turbines counter. The strategy is to have many mass elements in motion at any instant of time, perhaps by varying the starting time for each mass element, though that may not actually be necessary. The goal is to eliminate any “chattering” or vibrations associated with individual or widely spaced mass elements, but inertial effects may play the same role as the total mass in motion on the expellers reaches large and steady-state values.

Using the above logic and implementation, we need to find the net torque and from that find the net power required to operate each expeller. We do this by finding the incremental power at each instant and integrate from the initial to final torques for a single mass element and then sum the power needed to operate the total system of expellers at some fixed spin rate. The collateral goal is that our implementation should smooth out the granularity in the power required from the turbines driving the expeller systems.

The torque at any location along a fin is simply τ=r f_{cori}, where we have both r and f_{cori} as functions of angle and where f_{cori}=2m r ω². The instantaneous torque is then τ=2 m r² ω². The instantaneous power being delivered to keep the rotation rate constant is P=ωτ=2 m r² ω³. We have r as a function of θ, and if we integrate the instantaneous power from zero to θₑₓᵢₜ, we have the power required to accelerate a unit mass to the end of a fin at a constant expeller spin rate. The integral is analytic but showing the results does not illuminate any particular interpretation regarding design parameter optimization. The radius of the expellers only shows up in the value for θₑₓᵢₜ in that θₑₓᵢₜ˜Cosh⁻¹ [R/Rᵢ] to a high degree of accuracy. Consequently, once we know that the net recoil increases as the ratio R/Rᵢ increases, we can eliminate the smaller terms in the analytical solution to the integral, leaving a very accurate approximation for the power requirements based on performance goals for the system. Once we have the integrated power per unit mass, the total power requires the use of the total mass throughput per second.

To complete the picture of a parametric design of a propulsion unit using current space power sources, we will describe a small propulsion system that is driven by solar panels. This analysis requires defining a compact expeller array that is very small and, therefore, requires much less propulsion mass than necessary to provide sufficient thrust to accelerate off the surface of the Earth. Such Earth-launched systems will require the power-to-mass ratios provide by new types of nuclear reactors. However, for current space power sources, we can used solar power or isotopic nuclear thermal reactors of low power. Consider a solar panel array that produces 12 kw of electrical power. Using estimates of known technologies, we can posit a DC motor delivering 10 kw of shaft power to the expeller array. The total power system mass would be <100 kg. The retarder array will be chosen to be a small array that has a rotor that is 0.5 m in diameter with a spin rate of 10 rps. In this retarder system, R=0.25 m and Ri=0.05 m, which makes θₘₐₓ˜2.29 radians (˜131 degrees) and the retarder radial injection velocity for reaction mass is −15.9 m/sec radially inward from the retarder rim. The issue with the spin rate has to do with potential limits on the lifetime of the expeller array at much high sustained rotation rates. On the other hand, for either station-keeping or orbit changes, the operational duration for the retarder array can be limited. Consequently, we will only use this parametric analysis to find what propulsion we can achieve with the small propulsion unit we have defined.

We will adjust the mass flow per second in the retarder to meet the retarder power of 10 kw and from that find the number of expellers in the array to allow the mass per pulse per fin to be ˜1 gm. When we integrate the power for the system, we find generically that Pᵢₙₜ=(2 m w³/3) (Rₘₐₓ³−Rᵢ³), which when solved for m indicates that we require a mass throughput rate of ˜39 gm/sec of mass, which would require a single expeller with 40 fins, assuming that such a small number of fins allows the thrust to be smooth without introducing vibrations. For such a system, we can reduce the per injection pulse mass to a much smaller value which increasing the retarders in an array to ensure smooth operation. None the less, the integrated Coriolis force in the above system is then found to be ˜16.2 Nt. This force produces an acceleration of 0.0016 m/sec² on a 10,000 kg satellite, where the masses of the power sources and DC motors add about 1% to the overall system mass. In one hour, the satellite speed can be increased by ˜5.8 m/sec after moving a distance of 10.4 km. If the propulsion system contains a control system and two retarder arrays oriented for three-dimensional thrust vectoring, we would be able to mount the propulsion unit onto any satellite to shift its orbit. If the above 10⁴ kg satellite is moved from an Earth orbit to a Lunar orbit around the moon, the total propulsion duration to spiral from Earth to the moon would likely take several months, which is estimated by finding the decrease in speed needed to spiral from a low-Earth orbit into a low-Lunar orbit.

A parametric model for a “high powered” retarder system for Earth launch requires power-to-mass ratios (kw/kg) of the power source of over 100, with much higher ratios possible using new nuclear reactor technologies that are only experimental or theoretical at this time. In the parametric models, we can configure vehicles on the order of the space shuttle orbiter that can continuously thrust at 1 g acceleration, which allows the moon to be reached in ˜4 hours with a half-way reverse thrust to allow for lunar landing or orbiting. The power for such a system is several hundred megawatts of thermal power, a power level that was doubled in 1969 from the Pee Wee class of miniature nuclear reactors being tested under Project Rover for the NERVA rocket, and which was abandoned in 1972. However, while the requisite power levels were attained, the power-to-mass ratio was only ˜15, it could have potentially powered a retarder system for ground-launched systems for space travel.

What is claimed is:

1. A system for converting torque into a non-inertial propulsion force while conserving propellant mass by generating a net Coriolis recoil force, the system comprising:
a power source that generates torque;
an assembly, rotated by the torque, comprising:
a shaft, coupled to the power source to receive the torque;
a plurality of finned discs, coupled along the shaft for co-rotation, each of the finned discs providing a plurality of radially-oriented conduits; and
a means for injecting a pressurized fluid into the radially-oriented conduits, such that the interaction of the pressurized fluid with the finned discs provides a net Coriolis recoil force on the shaft.

2. The system of claim 1, wherein:
the system is an “expeller” system in which the means for injecting the pressurized fluid is arranged along the shaft and directs the pressurized fluid radially outwardly into openings between fins of the finned discs.

3. The system of claim 1, wherein:
the system is an “retarder” system in which the means for injecting the pressurized fluid is arranged beyond an outer circumference of the finned discs and directs the pressurized fluid radially inwardly into openings between fins of the finned discs.

4. A device for converting torque into a non-inertial propulsion force while conserving propellant mass, the device comprising:
a power source that generates torque;
an assembly, comprising:
a shaft, adapted at a first end to receive torque from the power source;
a plurality of finned discs, each having a planar base with a plurality of fins that extend from a central opening of the disc to an outer circumference thereof; and
complementary means, along the shaft and at the central opening of each of the plurality of finned discs, for coupling the plurality of finned discs for co-rotation on the shaft; and
an array of fluid injector nozzles, arranged relative to the assembly near the outer circumference, such that one fluid injector nozzle is provided for injecting a pressurized fluid in discrete droplets radially into an opening between adjacent fins.

5. The device of claim 4, wherein:
the plurality of fins is symmetrically arranged on a single side of the planar base.

6. The device of claim 5, wherein:
each of the plurality of fins is linear and arranged on a radius of the planar base.

7. The device of claim 4, wherein:
the finned discs are coupled along the shaft in close axial relationship, effectively defining a plurality of closed radial conduits of rectangular cross section.

8. The device of claim 4, wherein:
the complementary means for coupling the plurality of finned discs to the shaft comprises a plurality of slots arranged around the central opening of each finned disc and a corresponding plurality of keys along the shaft.

9. The device of claim 8, wherein:
the complementary means for coupling is sized and arranged to maintain a small standoff gap between the central opening and the shaft.

10. The device of claim 4, wherein:
a plurality of arrays of the fluid injector nozzles are provided in spaced angular relationship around the assembly.

11. The device of claim 4, wherein the power source generates thermal energy that is converted into rotational torque by a turbine.

12. The device of claim 11, wherein the power source is a nuclear reactor.

13. The device of claim 4, wherein the power source generates electrical energy that is converted into rotational torque by a motor.

14. The device of claim 13, wherein the power source is a bank of photovoltaic energy cells.

15. A method of converting torque into a non-inertial propulsion force while conserving propellant mass, comprising the steps of:
using a power source to generate torque;
transmitting the generated torque into an assembly comprising a shaft having a plurality of finned discs coupled axially along the shaft, such that the generated torque is coupled to and rotates the shaft, along with the coupled finned discs;
injecting a fluid, in a stream of discrete droplets, at an initial velocity into each of the finned discs at an outer circumference thereof, such that the fluid interacts with the fins, retarding the velocity of the fluid to a final velocity at a central opening of the finned disc, generating a recoil Coriolis force on the shaft; and
collecting the fluid at the central opening for reuse.

16. The method of claim 15, wherein:
the fluid is recycled for reinjection by a pair of pumps, mounted back to back for counter-rotation to cancel any torques and eliminate any angular pitch in the system.
